(19) United States
(12) Patent Application Publication
(10) Pub. No.: US 2017/0305438 A1
(43) Pub. Date: Oct. 26, 2017

(54) COMPUTER VISION MONITORING FOR A COMPUTER VISION SYSTEM

(71) Applicant: FTS Computertechnik GmbH, Wien (AT)

(72) Inventors: Stefan POLEDNA, Klosterneuburg (AT); Wilfried STEINER, Wien (AT); Manfred LETTNER, Wien (AT); Mehmed AYHAN, Wien (AT)

(21) Appl. No.: 15/521,326

(22) PCT Filed: Nov. 10, 2014
(86) PCT No.: PCT/AT2014/050268

§ 371 Date: Apr. 24, 2017

(30) Foreign Application Priority Data
Oct. 27, 2014 (AT) A 50766/2014

(51) Int. Cl. B60W 50/02; G06K 9/03; G06K 9/62; B60W 50/029

(52) U.S. Cl. CPC B60W 50/0205; G06K 9/6201; G06K 9/03; B60W 2050/0215; B60W 2050/022; B60W 2050/021; B60W 2050/0295

(57) ABSTRACT

Method for monitoring a computer vision system (CVS), said computer vision system (CVS) being part of a vehicle control system (VCS) of a vehicle (1000) that is used to maneuver said vehicle (1000) in 3D-space (3000), said computer vision system (CVS) being configured to monitor a surrounding area of the vehicle in real time and said computer vision monitor (CVM) monitoring the behavior of the computer vision system (CVS), comprising the steps of a.) providing the computer vision monitor (CVM) with information concerning a position (LM_POS) of at least one landmark (2000) in the 3D-space (3000), wherein said information is provided by a source, said source being independent of the computer vision system (CVS), b.) providing the computer vision monitor (CVM) with information concerning a current position (CUR_POS) of the vehicle (1000), c.) selecting based on steps a.) and b.) at least one landmark which falls within the range of vision of the computer vision system (CVS), d.) classifying the computer vision system (CVS) as being faulty when the computer vision system (CVS) fails to detect a configurable number of selected landmarks (2000).

### FIELD OF TECHNOLOGY

Road traffic injuries are estimated to be the eight leading cause of death globally, with approximately 1.24 million per every year on the world's road and another 20 to 50 million sustain non-fatal injuries as a result of road traffic crashes. The cost of dealing with the consequences of these road traffic crashes runs to billions of dollars. Current trends suggest that by 2030 road traffic deaths will become the fifth leading cause of death unless urgent action is taken.

Among the strategies which are proven to reduce road traffic injuries like reducing the urban speed, reducing drinking and driving and increasing seat-belt use is the strategy of providing new and improved vehicle safety systems, ranging from airbag systems, anti-lock breaking systems (ABS), electronic stability program (ESP), emergency brake assistant (EBA) to extremely complex advanced driver assistance systems (ADAS) with accident prediction and avoidance capabilities. Such driver assistance systems are increasing the traffic safety either by informing the driver about the current situation (e.g. night vision, traffic sign detection, pedestrian recognition), by warning the driver with regard to hazards (e.g. lane departure warning, surround view), or they selectively control actuators (e.g. adaptive light control, adaptive cruise control, collision avoidance, emergency braking).

To perform such functions such as the listed above, ADAS currently faces increasing system complexity and growing number of requirements, e.g. from safety standards. Automobiles are equipped with embedded electronic systems which include lots of Electronic Controller Units (ECUs), electronic sensors, signals bus systems and coding. Due to the complex application in electrical and programmable electronics, the safety standard ISO 26262 has been developed to address potential risk of malfunction for automotive systems, Adapted from the IEC 61508 to road vehicles, ISO 26262 is the first comprehensive automotive safety standard that addresses the safety of the growing number of electric/electronic and software intensive features in today's road vehicles. ISO 26262 recognizes and intends to address the important challenges of today's road vehicle technologies. These challenges include (1) the safety of new electrical, electronic (E/E) and software functionality in vehicles, (2) the trend of increasing complexity, software content, and mechatronics implementation, and (3) the risk from both systematic failure and random hardware failure.

Given the fact that current and future advanced driver assistance systems rely heavily on environment perception and most of them are using a computer vision system CVS, additional attention needs to be paid, especially to safety related and safety-critical applications using the CVS for safety-related actions in order to satisfy the automotive safety standards. One way to satisfy the safety standards is to ensure that the CVS is not used for critical decisions in the presence of software or hardware failure of the CVS. Therefore in order to improve the reliability, in this invention we present a novel method and devices to monitor the correct operation of CVS for ADA during vehicle operation by introducing a computer vision monitor CVM.

The invention also applies to fields adjacent to automotive, for example, to aerospace, in particular unmanned aerospace applications, warehouse management, industrial automation, and in general all application areas in which a vehicle 1000 needs to move safely in a 3D-space 3000, In the aforementioned application areas examples for vehicles would be respectively, unmanned aeronautical vehicles (UAVs), carts that autonomously maneuvering in a warehouse, or mobile robots autonomously maneuvering in a factory hall.

### SUMMARY OF THE INVENTION

The invention improves the reliability of a vehicle control system VCS, that incorporates a computer vision system CVS, to safely maneuver the vehicle in a 3D-space 3000 by using a computer vision monitor CVM that monitors whether the operation of the computer vision system CVS is correct or not. To do so, the CVM has locally stored information of the expected positions LM_POS of landmarks 2000 in the 3D-space 3000 as well as information regarding the current position CUR_POS of the vehicle 1000. The CVM then uses the expected positions LM_POS of the landmarks 2000 and CUR_POS of the vehicle 1000 to monitor, whether the CVS is correctly recognizing said landmarks 2000 at said positions CUR_POS. If the CVS does correctly recognize said landmarks 2000, the CVM assumes that the CVS is working correctly. If the CVS fails to recognize a landmark 2000 or several landmarks 2000 within a given time interval, the CVM detects an unexpected behavior of the CVS. In this case, the CVM reports the unexpected behavior to the vehicle control system VCS, which may then trigger different actions, e.g. stopping the vehicle 1000. Of course, the VCS may only act upon the computer vision monitor reporting a certain number of unexpected behaviors of the computer vision system CVS, for example to avoid situations in which the landmark 2000 is blocked of sight of the camera vision system CVS.

The invention relates to a method for monitoring a computer vision system CVS, said computer vision system CVS being part of a vehicle control system VCS of a vehicle 1000 that is used to maneuver said vehicle 1000 in 3D-space 3000,
said computer vision system CVS being configured to monitor a surrounding area of the vehicle in real time and
said computer vision monitor CVM monitoring the behavior of the computer vision system CVS,
   comprising the steps of
a.) providing the computer vision monitor CVM with information concerning a position LM_POS of at least one landmark 2000 in the 3D-space 3000, wherein said information is provided by a source, said source being independent of the computer vision system CVS,
b.) providing the computer vision monitor CVM with information concerning a current position CUR_POS of the vehicle 1000,
c.) selecting based on steps a.) and b.) at least one landmark which falls within the range of vision of the computer vision system CVS,
d.) classifying the computer vision system CVS as being faulty when the computer vision system CVS fails to detect a configurable number of selected landmarks 2000.

A configurable number of selected landmarks 2000 can be for instance at least or exactly one landmark 2000, two landmarks 2000 or at least a certain multitude of landmarks 2000. Also, the steps a.) to be c.) can be repeated iteratively until a certain number of landmarks 2000 are selected, thus allowing the computer vision monitoring system CVM to classify the computer vision system CVS in the subsequent step d.).

Preferably, in step d) the computer vision monitor CVM uses the information of steps a) and b) to determine an expectancy value with reference to at least one selected land mark 2000 and wherein said expectancy value is compared with information provided by the computer vision system CVS, wherein the computer vision monitor classifies the computer vision system CVS as being faulty when the difference between the expectancy value and the information provided by the computer vision system CVS exceeds a predetermined threshold.

Additionally, the computer vision monitor CVM might use natural landmarks. Within the disclosure of this invention the term “natural landmark” refers to any landmark which is not placed in the 3-D space solely for the purpose of being recognized by the computer vision system CVS. Such a natural landmark can be given by geographical features like mountains, rivers as well as traffic signs etc.

Alternatively, artificial landmarks might be explicitly placed in the 3D-space as part of the computer vision monitor CVM method. The term “artificial landmark” refers to any landmark which is placed solely for the purpose of being recognized by the computer vision system CVS. An example for an artificial landmark is a board having a particular shape or containing a particular symbol, which can be easily recognized by a computer vision system CVS. Such symbols can be geometric forms as rectangles or triangles having a strong contrast to surrounding space. The symbols can be for example in white colour on dark background or vice versa. The board can be shaped like a road sign. Examples for such road signs or other visuals are signs or visuals that visualize an individual person, or groups of people, or one or a multitude of vehicles.

In case that the computer vision monitor CVM detects a failure of the computer vision system CVS the vehicle control system VCS can be configured to bring the vehicle into a safe state.

Preferably, in step a.) the knowledge of the position LM_POS (i.e. information concerning a position) of at least one landmark 2000 is provided by a landmark maintenance center 4000.

It can be foreseen, that the vehicles communicates/reports the computer vision system CVS detected failures (misbehavior) and corresponding land marks 2000 to the landmark maintenance center 4000.

In step b.), the knowledge of the current position CUR_POS of the vehicle 1000 can be provided by means of a Global Positioning System GPS system.

Alternatively, knowledge of the current position CUR_POS of the vehicle 1000 in step b.) is provided by a landmark 2000, in particular by means of a wireless connection.

Also, it can be foreseen, that in step a.) knowledge of the position LM_POS of at least one landmark 2000 is provided by a landmark 2000, in particular by means of a wireless connection.

The invention also refers to a system for monitoring a computer vision system CVS comprising a computer vision monitor CVM, said computer vision system CVS being part of a vehicle control system VCS of a vehicle 1000, said computer vision system CVS being configured to monitor a surrounding area of the vehicle in real time, said system being configured to perform a method according to any of the preceding claims.

### BRIEF DESCRIPTION OF FIGURES

In the following we discuss several exemplary embodiments of the invention with reference to the attached drawings. it is emphasized that these embodiments are given for illustrative purpose and are not to be construed as limiting the invention.

FIG. 1 depicts a 3D-space in which a landmark is positioned and a vehicle moves around.

FIG. 2 depicts relations between the elements related to the computer vision system.

FIG. 3 depicts a computer vision monitor method according to the invention.

FIG. 4 depicts the interaction between the computer vision monitor and the vehicle control system in more detail.

FIG. 5 depicts a 3D-space together with a vehicle and a landmark.

FIG. 6 depicts an extended realization of a computer vision monitor.

FIG. 7 depicts another extended realization of the computer vision monitor.

FIG. 8 depicts an exemplary operation of a landmark maintenance center.

FIG. 9 depicts a vehicle equipped with a computer vision monitoring system according to the invention.

FIG. 10 depicts a vehicle equipped with another variant of a computer vision monitoring system according to the invention.

### EXEMPLARY EMBODIMENTS

In the following we discuss exemplary embodiments of many possible embodiments of the invention, which can be freely combined unless stated otherwise.

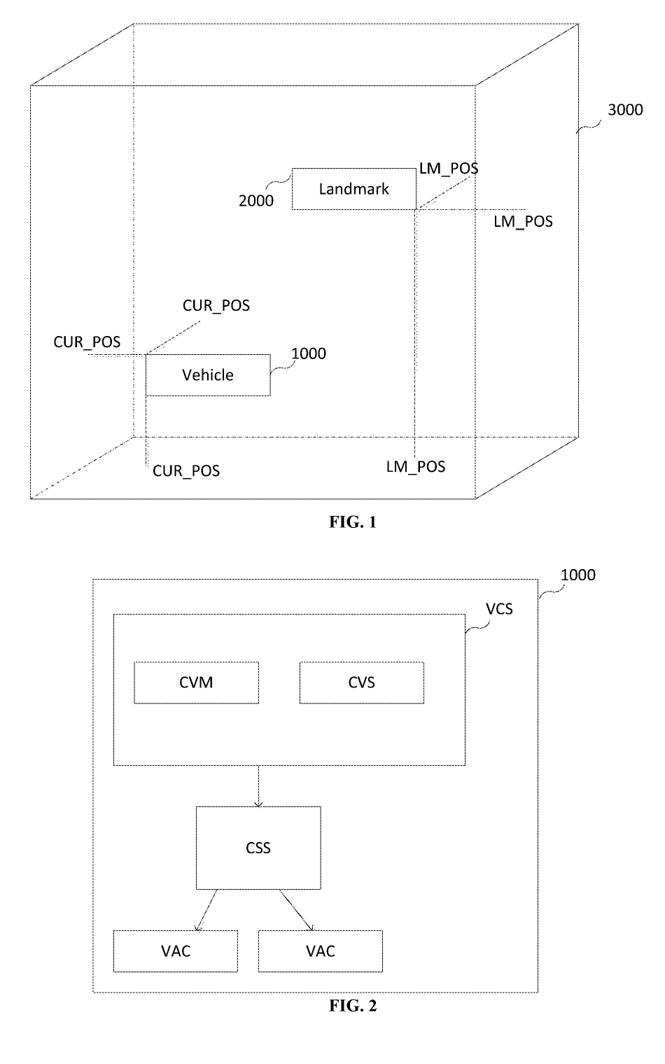

In FIG. 1 a 3D-space 3000 is depicted in which a landmark 2000 is positioned and in which a vehicle 1000 moves around. The position LM_POS of the selected landmark 2000 is known to the vehicle 1000. Examples for landmarks 2000 include geographic entities like a hill, a mountain, or courses of rivers, road signs, or visuals on a road or next to a road, or buildings or monuments. The vehicle 1000 may for example obtain the knowledge of the position LM_POS of the associated landmark 2000 from a source, said source being independent of the computer vision system CVS. This source can comprise a vehicle-local storage medium such as a flash-drive, hard disk, etc. The vehicle 1000 may also obtain the knowledge of the position LM_POS of the associated landmark 2000 from a remote location, for example a data center, via a wireless connection. Furthermore, the vehicle 1000 has means to establish its current location CUR_POS in the 3D-space 3000, e.g., by means of the Global Positioning System (GPS). The landmarks 2000 can be existing landmarks, such as traffic signs, geological factors, etc. or landmarks particularly placed in the 3D-space as part of the computer vision monitoring CVM method. For example, the landmarks 2000 can be dedicated road signs or other visuals on a road or next to a road installed in the 3D-space 3000 that are especially installed for the computer vision monitoring method CVM, so called artificial landmarks. An example for an artificial landmark is a board having a particular shape or containing a particular symbol, which can be easily recognized by a computer vision system CVS. Such symbols can be geometric forms as rectangles or triangles having a strong contrast to surrounding space. The symbols can be for example in white colour on dark background or vice versa. The board can be shaped like a road sign. Examples for such road signs or other visuals are signs or visuals that visualize an individual person, or groups of people, or one or a multitude of vehicles.

In FIG. 2 the relations between the vehicle 1000, the vehicle control system VCS, the computer vision system CVS, the computer vision monitor CVM, a communication subsystem CSS, as well as, vehicle actuators are depicted:
The vehicle 1000 incorporates a vehicle control system VCS.
The vehicle control system VCS incorporates a computer vision system CVS and a computer vision monitor CVM. The computer vision system CVS being able to monitor at least parts of the surrounding of the vehicle 1000 in real-time, i.e., it is capable to capture and process images acquired of said parts of the surrounding of the vehicle fast enough such that maneuvering actions of the vehicle 1000 can be deduced from the captured and processed images.
The vehicle control system VCS communicates with vehicle actuators VAC using a communication subsystem CSS.

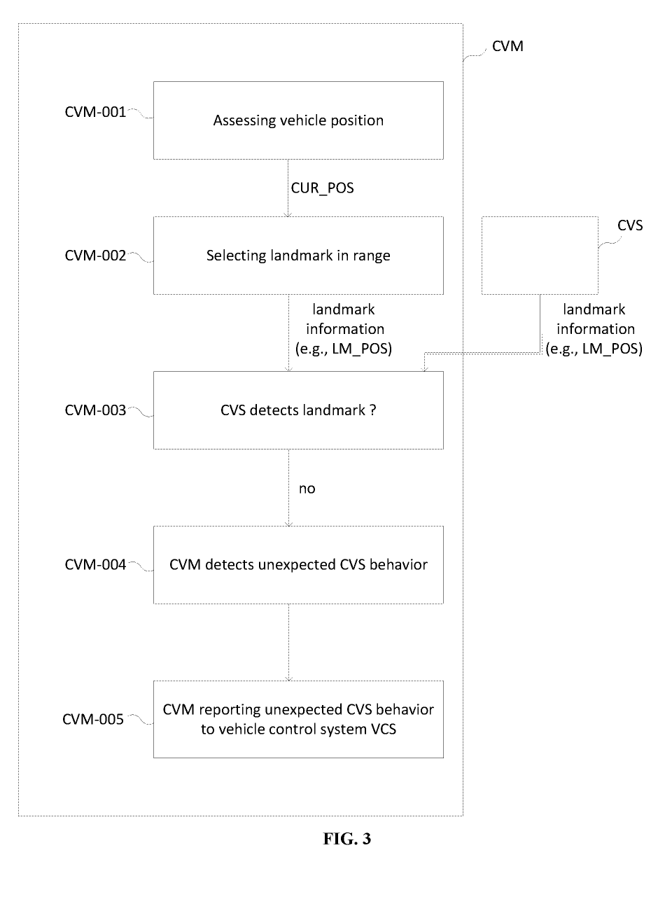

In FIG. 3 the computer vision monitor method is depicted in detail. The method includes the following steps:
CVM_001: Assessing the current vehicle position CUR_POS, e.g., by means of GPS
CVM_002: Selecting a landmark 2000 in the range of the computer vision system CVS of the vehicle control system VCS
CVM_003: Evaluating whether the computer vision system CVS detects the landmark 2000 selected in CVM_002,
CVM_004: The CVM classifying the computer vision system CVS as being faulty when the CVS fails to detect one or a defined multitude of selected landmarks 2000 in step CVM_002. In particular, a detection fault can recognized as such, when the computer vision monitor CVM calculates an expectancy value with reference to at least one selected landmark 2000 falling in the range of vision of the computer vision system CVS, wherein said expectancy value is compared with information provided by the computer vision system CVS, and the difference between the expectancy value and the information provided by the computer vision system CVS exceeds a predetermined threshold. Such a threshold be defined as for example by a time criteria: In case the position of a vehicle is in proximity to a specific landmark 2000, said landmark falling within the range of vision of the CVS, the computer vision system CVS can be classified as being faulty in case the computer vision system CVS fails to recognize the landmark 2000 within a particular period of time, for example 10 ms. Also, another criterion for a threshold can be given by taking the time into consideration in which a particular landmark 2000 is detected by the computer vision system CVS. In case a specific landmark 2000 has already left the range of vision of a CVS (as a consequence of vehicle movement) this landmark 2000 should not be recognized by the CVS anymore. If the computer vision system CVS still signals to recognized a landmark 2000 being already out of the range of vision of the CVS, the computer vision system CVS can be classified as being faulty (“system freeze”). In a preferred embodiment landmarks a placed in a proximity to each other, that allows the computer vision system to recognize at least two landmarks 2000 at the same time.
CVM_005: The CVM reporting the unexpected CVS behavior to the vehicle control system VCS for further processing.

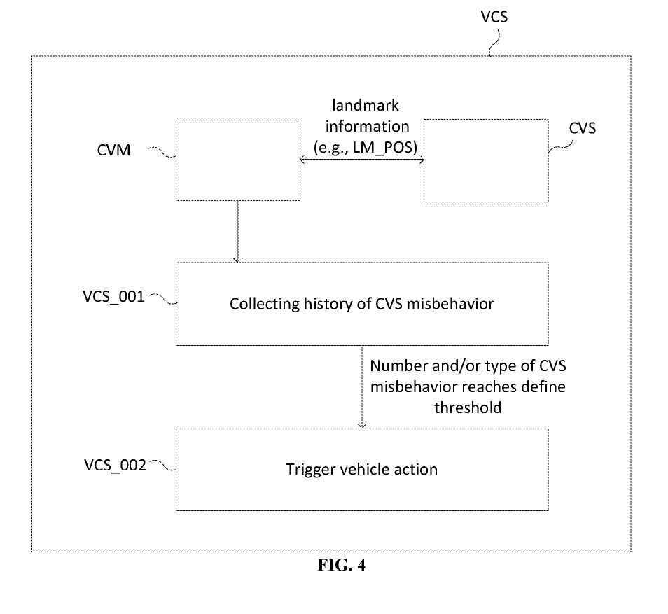

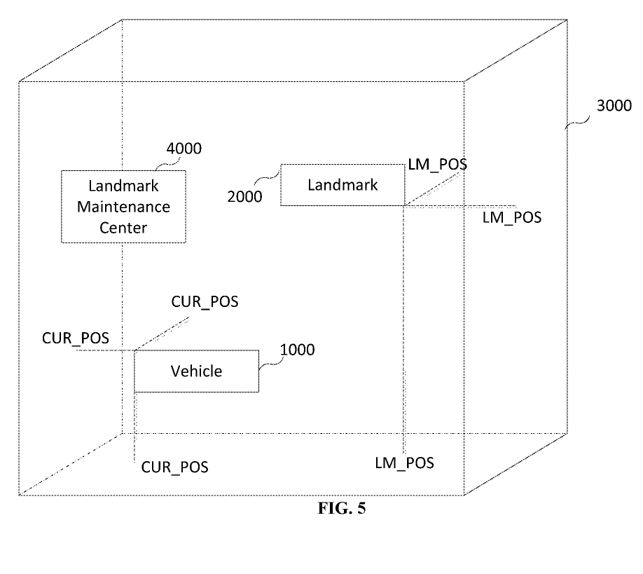

In FIG. 4 the interaction between the computer vision monitor CVM and the vehicle control system is depicted in more detail:
VCS_001: the VCS collects information of the CVS misbehavior, e.g., the CVM reports that the CVS failed to detect one or a defined multitude of consecutive landmarks 2000
VCS_002: once the number and/or type of reported CVS misbehaviors reaches a given threshold (for example one, two, three, or more), the VCS triggers some vehicle 1000 action or a multitude of vehicle 1000 actions, for example,
   it signals to stop the vehicle 1000, or
   it disables the CVS system and it notifies the vehicle 1000 operator that the camera vision system CVS is disabled.

In FIG. 5 again a 3D-space 3000 is depicted together with a vehicle 1000 and a landmark 2000, in addition, in this 3D-space 3000 also a landmark maintenance center 4000 is depicted, said land mark maintenance center 4000 providing the vehicle with knowledge of the position of landmarks 2000. The vehicle 1000 is capable of communicating directly or indirectly with a landmark maintenance center 4000, e.g., using one or many wireless communication link or links, for example following telecom standards such as 3GPP or IT standards such as IEEE 802.11 or some following or upcoming standards.

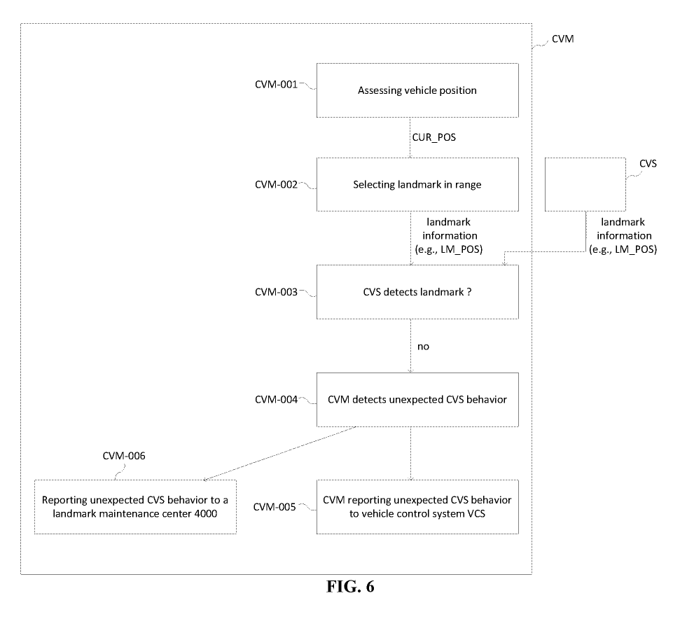

In FIG. 6 an extended realization of the computer vision monitor CVM is depicted. CVM_006: when the CVM detects an unexpected CVS behavior, it reports the CVS misbehavior, for example that the CVS failed to detect one, two, or a multitude of the landmarks 2000, to the landmark maintenance center 4000. Reporting allows the landmark maintenance center 4000 to identify issues with landmarks 2000, e.g., a landmark 2000 may be permanently damaged and, thus, not recognizable by a computer vision system CVS.

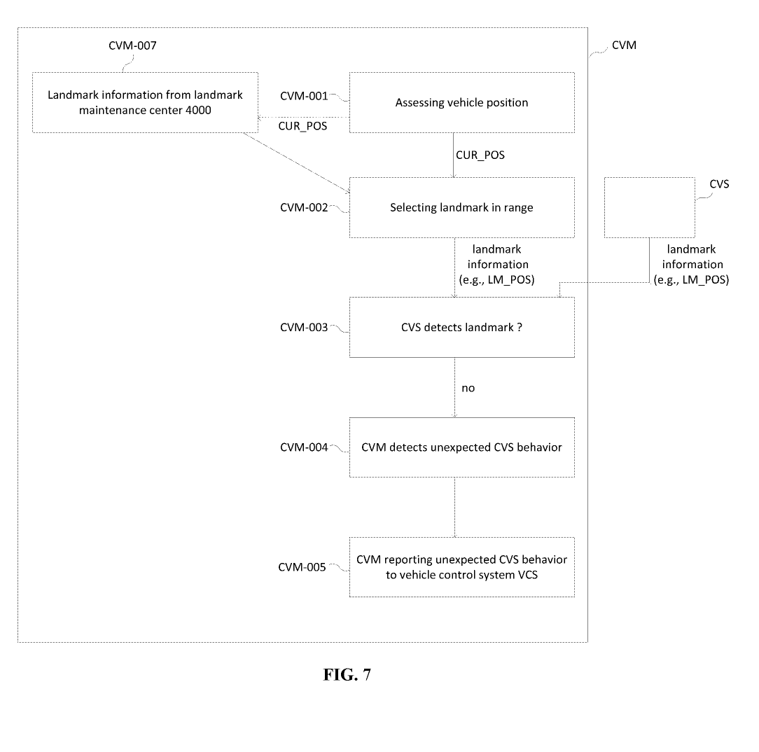

In FIG. 7 another extended realization of the computer vision monitor CVM is depicted. CVM_007: the landmark maintenance center 4000 informs the CVM of the current status of landmarks 2000. For doing this the landmark maintenance center 4000 may take the vehicle position CUR_POS into account, e.g., to deliver information only for landmarks in the surrounding of the vehicle 1000.

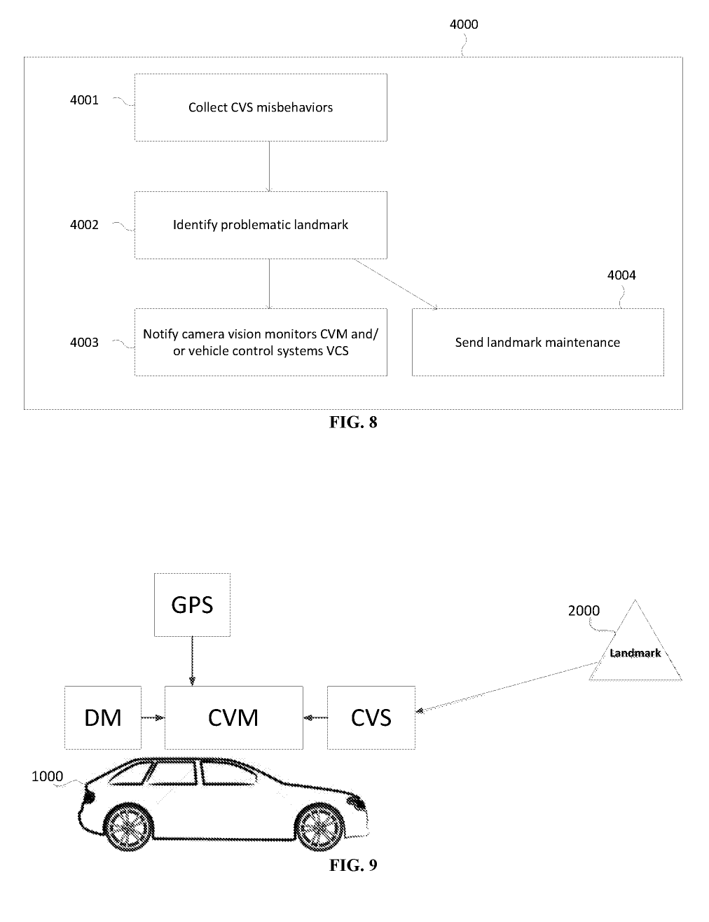

In FIG. 8 an example operation of the landmark maintenance center 4000 is described:
4001: the landmark maintenance center 4000 collects the CVS misbehaviors as reported by one or many computer vision monitors CVM of one or many vehicles 1000
4002: based on the collected information, the landmark maintenance center 4000 identifies problematic landmarks 2000, e.g., a landmark 2000 for which several vehicles 1000 report a CVS misbehavior can be identified to be damaged.
4003: the computer vision monitors CVM and/or the vehicle control systems VCS are informed that the identified landmark 2000 may be damaged.
4004: the landmark maintenance center 4000 may trigger a maintenance activity, such as sending a repair crew to the damaged landmark's site.

In FIG. 9 an example vehicle 1000 is depicted that realizes a computer vision monitor CVM to monitor the correct behavior of a computer vision system CVS. In the example in FIG. 9 the vehicle obtains knowledge of the current position CUR_POS of the vehicle 1000 by means of GPS (global positioning system). Furthermore, the vehicle 1000 obtains knowledge about landmarks 2000 in the surrounding of the vehicle (and in particular their position LM_POS) from a digital map DM that is locally stored in the vehicle 1000.

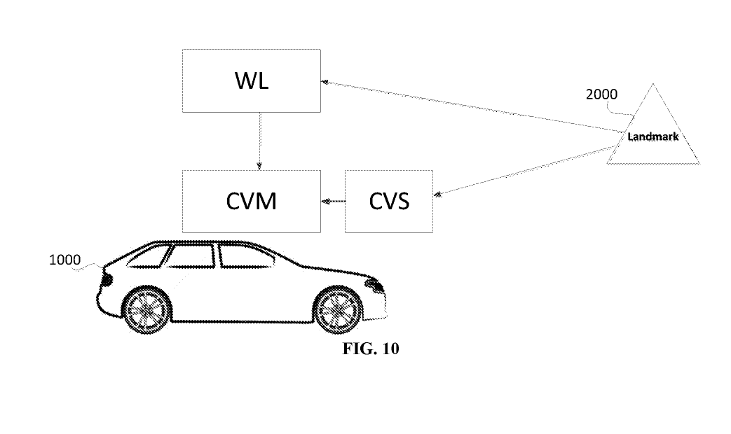

In FIG. 10 another example of a vehicle 1000 is depicted that realizes a computer vision monitor CVM to monitor the correct behavior of a computer vision system CVS. In the example in FIG. 10 the vehicle obtains knowledge of its current position CUR_POS and the existence of landmarks 2000 in the surrounding of the vehicle 1000 and their position LM_POS from the landmarks 2000 themselves, for example by means of a wireless connection WL. A landmark 2000, may thus instruct a vehicle 1000 of the landmarks 2000 existence by transmitting information over a wireless communication channel to the vehicle 1000, where the transmitted information can be interpreted by the vehicle 1000 as CUR_POS and LM_POS.

1. A method for monitoring a computer vision system (CVS) by a computer vision monitor (CVM), said computer vision system (CVS) being part of a vehicle control system (VCS) of a vehicle (1000) that is used to maneuver said vehicle (1000) in 3D-space (3000),
said computer vision system (CVS) being configured to monitor a surrounding area of the vehicle in real time and
said computer vision monitor (CVM) monitoring the behavior of the computer vision system (CVS),
the method comprising the steps of
a.) providing the computer vision monitor (CVM) with information concerning an expected position (LM_POS) of at least one landmark (2000) with regard to the 3D-space (3000), wherein said information is provided by a source, said source being independent of the computer vision system (CVS),
b.) providing the computer vision monitor (CVM) with information concerning a current position (CUR_POS) of the vehicle (1000) with regard to the 3D-space,
c.) selecting based on steps a.) and b.) at least one landmark which falls within the range of vision of the computer vision system (CVS),
d.) classifying the computer vision system (CVS) as being faulty when the computer vision system (CVS) fails to detect a configurable number of selected landmarks (2000).

2. The method of claim 1, wherein in step d) the computer vision monitor (CVM) uses the information of steps a) and b) to determine an expectancy value with reference to at least one selected land mark (2000) and wherein said expectancy value is compared with information provided by the computer vision system (CVS), wherein the computer vision monitor classifies the computer vision system (CVS) as being faulty when the difference between the expectancy value and the information provided by the computer vision system (CVS) exceeds a predetermined threshold.

3. The method of claim 1, wherein the computer vision monitor (CVM) uses natural landmarks.

4. The method of claim 1, wherein artificial landmarks are explicitly placed in the 3D-space as part of the computer vision monitor (CVM) method.

5. The method of claim 1, wherein in case that the computer vision monitor (CVM) detects a failure of the computer vision system (CVS) the vehicle control system (VCS) brings the vehicle into a safe state.

6. The method of claim 1, wherein in step a.) knowledge of the position (LM_POS) of at least one landmark (2000) is provided by a landmark maintenance center (4000), said landmark maintenance center (4000) being configured to document misbehaviors as reported by one or many computer vision monitors CVM of one or many vehicles, wherein the vehicle communicates/reports the computer vision system (CVS) detected failures and corresponding landmarks (2000) to the landmark maintenance center (4000).

7. The method of claim 6, wherein the maintenance center (4000) triggers a maintenance activity, such as sending a repair crew to the damaged landmark's site.

8. The method of claim 1, wherein in step b.) knowledge of the current position (CUR_POS) of the vehicle (1000) is provided by means of a Global Positioning System (GPS) system.

9. The method of claim 1, wherein in step b.) knowledge of the current position (CUR_POS) of the vehicle (1000) is provided by a landmark (2000), in particular by means of a wireless connection.

10. The method of claim 1, wherein in step a.) knowledge of the position (LM_POS) of at least one landmark (2000) is provided by a landmark (2000), in particular by means of a wireless connection.

11. A system for monitoring a computer vision system (CVS) comprising a computer vision monitor (CVM), said computer vision system (CVS) being part of a vehicle control system (VCS) of a vehicle (1000), said computer vision system (CVS) being configured to monitor a surrounding area of the vehicle in real time, said system being configured to perform the method of claim 1.
